(19) United States
(12) Patent Application Publication
(10) Pub. No.: US 2012/0208169 A1
(43) Pub. Date: Aug. 16, 2012

(54) Method for Measuring and Training Intelligence

(75) Inventors: Sissela Bergman Nutley, Bromma (SE); Torkel Klingberg, Bromma (SE); Jonas Beckeman, Johanneshov (SE)

(73) Assignee: COGMED AMERICA INC, NAPERVILLE, IL (US)

(21) Appl. No.: 13/394,172

(22) PCT Filed: Aug. 19, 2010
(86) PCT No.: PCT/US10/45953

§ 371 Date: Apr. 30, 2012

Related U.S. Application Data
(60) Provisional application No. 61/235,035, filed on Sep. 5, 2009.

(51) Int. Cl. G09B 7/00

(52) U.S. Cl. 434/362

(57) ABSTRACT

The computer generates geometrical figures based on predefined parameter values. The parameter values are ranked according to difficulty level so that the computer may generate tasks that visually look differently but are based on the same set of parameter values.

### TECHNICAL FIELD

The invention relates to a method for measuring and training fluid intelligence.

### BACKGROUND OF INVENTION

There have been many attempts to train intelligence with mixed results. Many studies lack adequate control groups so that the training results are not very credible. One of the principles of cognitive training is that training needs to be performed close to the individual's capacity in order to have any effect. For example, too easy or too difficult training tasks will not have any effect. One of the methodological problems is thus to create a way to present automatically generated problems with a specific difficulty level.

### SUMMARY OF THE INVENTION

The method of the present invention provides a solution to the above outlined problems. The computer automatically generates geometrical figures based on sets of predefined parameter values. The parameter value sets are ranked according to difficulty levels so that the computer may generate tasks that visually look differently but are at the same difficulty level and based on the same set of parameters. More particularly, the method is for computerized training to improve the fluid intelligence of a user. A first pattern of symbols that follows a first set of parameter values is provided. The user responds in a first response to the first pattern of symbols by selecting response options. A computer determines whether the first response is correct. When the first response is correct, the computer generates a second pattern that is different compared to the first pattern. The second pattern is preferably more difficult than the first pattern. The user responds in a second response to the second pattern. The computer determines whether the second response is correct. When the second response is incorrect, the computer generates a third pattern that is different from the first pattern. The third pattern is preferably based on the first set of parameter values. When the first response is incorrect, the computer generates a fourth pattern that is less difficult than the first pattern. When the second response is correct, the computer generates a fifth pattern that is more difficult than the second pattern.

### BRIEF DESCRIPTION OF DRAWINGS

FIG. 1 is a schematic view of a repeated pattern exercise according to the present invention;

FIG. 2 is a schematic view of a sequential order exercise according to the present invention;

FIG. 3 is a schematic view of a classification exercise according to the present invention;

FIG. 4 is a schematic view of an exercise according to the present invention;

FIG. 5 is a schematic view of an exercise according to the present invention;

FIG. 6 is a schematic view of an exercise according to the present invention;

FIG. 7 is a schematic view of an exercise according to the present invention;

FIG. 8 is a schematic view of an exercise according to the present invention;

FIG. 9 is a schematic view of an exercise according to the present invention;

FIG. 10 is a schematic view of an exercise according to the present invention;

FIG. 11 is a schematic view of an exercise according to the present invention;

FIG. 12 is a schematic view of an exercise according to the present invention;

FIG. 13 is a schematic view of an exercise according to the present invention;

FIG. 14 is a schematic view of an exercise according to the present invention;

FIG. 15 is a schematic view of an exercise according to the present invention;

FIG. 16 is a schematic view of an exercise according to the present invention;

FIG. 17 is a schematic view of an exercise according to the present invention;

FIG. 18 is a schematic view of an exercise according to the present invention;

FIG. 19 is a schematic view of an exercise according to the present invention;

FIG. 20 is a schematic view of an exercise according to the present invention;

FIG. 21 is a schematic view of an exercise according to the present invention;

FIG. 22 is a schematic view of an exercise according to the present invention;

FIG. 23 is a schematic view of an exercise according to the present invention; and

### DETAILED DESCRIPTION

The training scheme of the present invention may be based on at least three different kinds of non-verbal neuro-psychological tests that include non-verbal reasoning tasks that may be used to measure and train fluid intelligence by using abstract symbols that follow carefully designed algorithms to create training exercises at very specific difficulty levels. Fluid intelligence may be defined as the ability to, independent of previous knowledge, identify patterns and relations and infer and implement rules. The algorithms allow the difficulty level to be analyzed based on different predefined parameters/factors which then may be separately manipulated. The algorithms may also be used to automatically generate new training questions or tasks at a very specific difficulty level that may be used to repeatedly train the users at the difficulty level for optimal effectiveness. The underlying rules and/or parameters for the exercises may be ranked and stored in a database. In this way, the difficulty level is scalable and can easily be adjusted to the user's performance i.e. the training load is adaptive. As indicated below, the appearance of the exercises i.e. the selection of symbols to be displayed may be automatically and randomly generated so that each exercise looks differently although the exercise may be based on the same parameters.

The term “Dimensions” may be defined as the parameters that are used to describe a card. The basic dimensions are: Color, Number (of dots), Position, Shape and Size. Advanced dimensions such as Pie-Slices/Filled-Slice, Multi-Color, Rotation-Angle, and possibly animated dimensions like movements may also be used. The term “Question” may be defined as the cards and blanks that are presented in the upper part of the screen. The term “Answer cards” may be defined as the cards that the user can select from to fill the blanks in the Question. The term “Problem definition” may be defined as the set of instructions (parameters) used by the system for generating a problem to be solved (the Question and the Answer cards). Some examples may bee NumCards (number of total slots in the “Question”, including blanks), NumBlanks (number of blanks in the Question), and Dimensions (which dimensions should be used in the generation process). A single Problem definition can be used to generate many visually different problems. The term “Rule(s)” may be short for “Rule dimension(s)”, and signifies what the Dimensions are that the user should identify as part of the pattern.

In other words, the actual figures/symbols generated could be randomly selected (so that the display looks visually different) while at the same time the same underlying parameters/rule is being trained. For example, the exercise could include a certain pattern that is repeated for the symbol and the color changes with every other symbol.

It has been surprisingly discovered that the user's fluid intelligence can be improved in a verifiable way by repeatedly going through the training exercises of the present invention. For example, the user may do the exercises for 15 minutes a day or any other suitable time period for several weeks. Preferably, the users follow a controlled training scheme to regularly train in a way that improves the fluid intelligence. In the preferred embodiment of the present invention, all the training tasks are taken on a computer that runs on a suitable computer program. The computer is also used to automatically display and generate the various displays of the exercises as described in more detail below. Preferably, the exercises/tasks of the computerized games only include geometrical figures such as circles, squares, triangles, hexagonal figures etc. The various tasks or exercises have different difficulty levels and follow predefined algorithms.

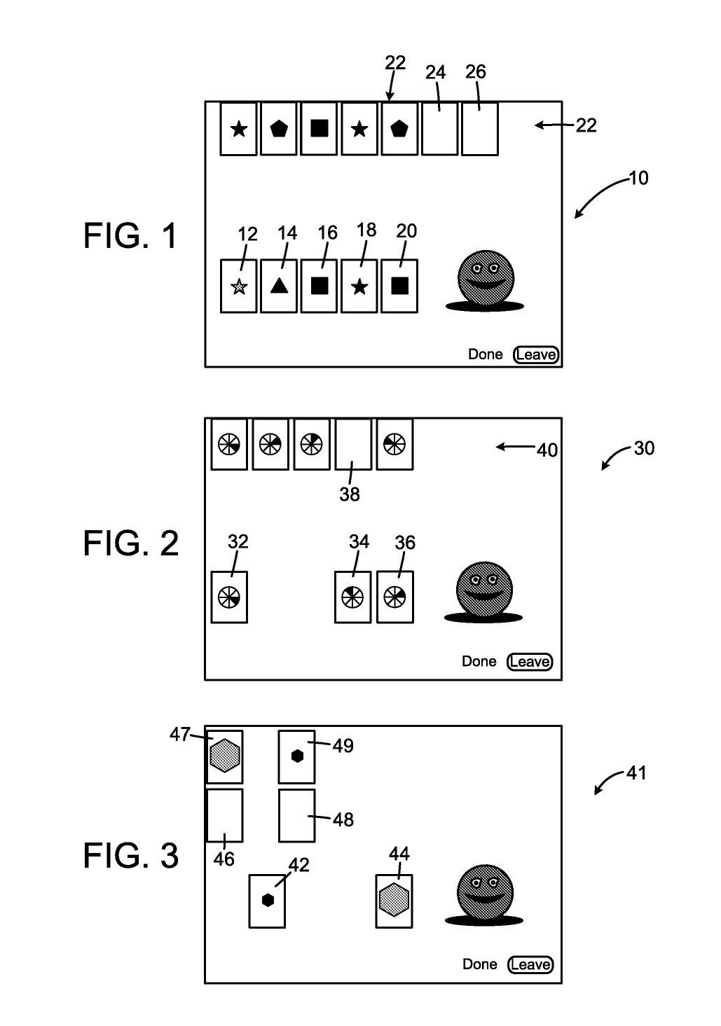

There are at least three kinds of tests or training methods that include repeated patterns, sequential orders and classification. In the repeated patterns tasks, the user is asked to discover patterns that exist and select a response from a number of proposed geometrical figures so that the same pattern continues. An example of a repeated pattern exercise 10 is shown in FIG. 1. The user is asked to select a response from the options 12, 14, 16, 18 and 20 to fill in the missing spaces 24, 26 to complete the repeated pattern 22. In the sequential order tasks the user is asked to discover the sequence that exists and select a response from a number of proposed geometrical figures to complete the sequence. An example of a sequential order exercise 30 is shown in FIG. 2. The user is asked to select a response from the options 32, 34 and 36 to fill in the blank slot 38 in the sequential order 40. In the classification tasks the user is asked to pair the proposed responses with the displayed geometrical figures so that they are matched according to certain characteristics. An example of a classification exercise 41 is shown in FIG. 3. The user is asked to select a response from options 42, 44 to fill in the blank slots 46, 48 to match the geometrical FIGS. 47, 49.

As indicated above, the various exercises have different difficulty levels that have been empirically tested on prior subjects or users to calibrate the difficulty levels of each exercise in an optimal way. When the user trains by doing the exercises the user eventually become more able to handle and successfully respond to tasks at higher difficultly levels.

The repeated pattern exercises use certain dimensions to serve as a basis for the rule system. The dimensions may include color, size, shape and a number of dots. All the dimensions may be of at least seven different variations such as seven different colors and shapes etc. Other factors that may be systematically varied include the length of the pattern, the number of distracting cards/options, the number of blank spaces and the number of rows the cards are presented on. In the sequential order exercise the size may vary and up to nine or more different positions may be used. A combination of dimensions may also be used in the exercises.

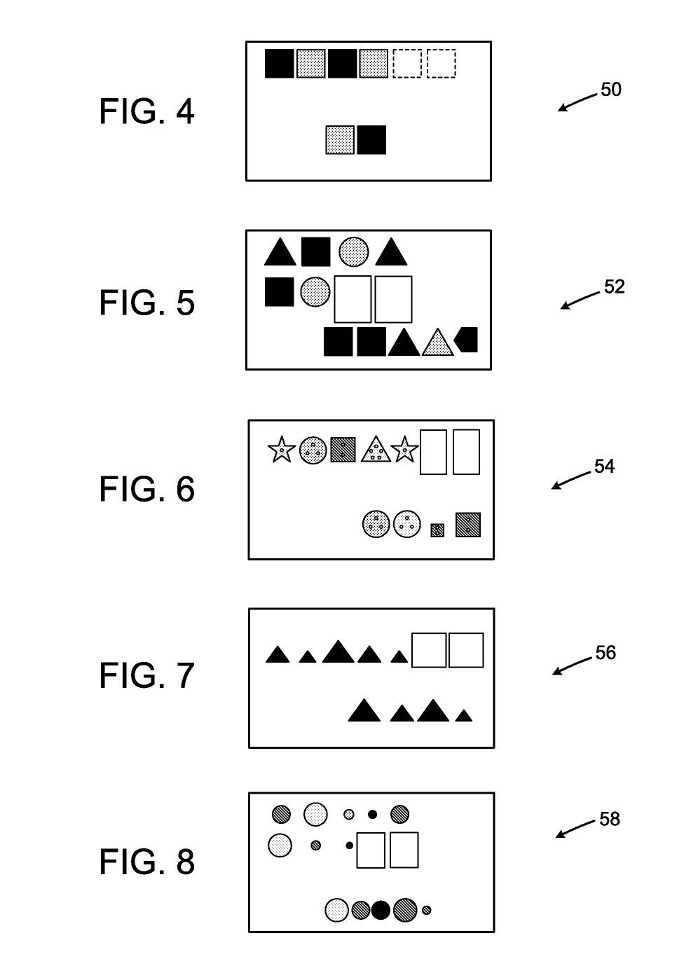

FIGS. 4-8 show examples of problem definition parameters of repeated pattern exercises. More particularly, FIG. 4 shows an exercise 50 that may be used to explain the parameter “number of cards.” In the example there are six cards in the upper row. An additional problem definition parameter in this example is the rule dimension parameter color. The task/exercise has a pattern length of two with no distracting cards.

FIG. 5 shows an exercise 52 that may be used to illustrate the parameter “number of distracting cards.” Distracting cards are the cards that do not fit into the pattern. The example shown in FIG. 5 has three distracting cards, two rule dimensions (color and form) and the pattern length is three. The distracting cards only differ from the correct cards in one dimension. One of the squares and one of the triangles differ regarding color and the five-sided shape differs regarding shape compared to the correct response.

FIG. 6 illustrates an exercise 54 that may be used to explain the parameter “number of rules.” There are four different rule dimensions (color, shape, size and number of dots) that may be used individually or in combinations so that there are up to three different rules that may be used at the same time. In this example, there are three rules (color, shape and number of dots). The pattern length is four and there are two distracting cards.

FIG. 7 shows an exercise 56 that may be used to illustrate the parameter “pattern length.” The example has a pattern length of three. There is one rule dimension (size) and there are two distracting cards.

FIG. 8 shows an exercise 58 that may be used to illustrate the parameter “number of rows.” In the example the pattern is displayed on two rows. There are two rule dimensions (color and size). The exercise shown in FIG. 8 has three distracting cards and the pattern length is four.

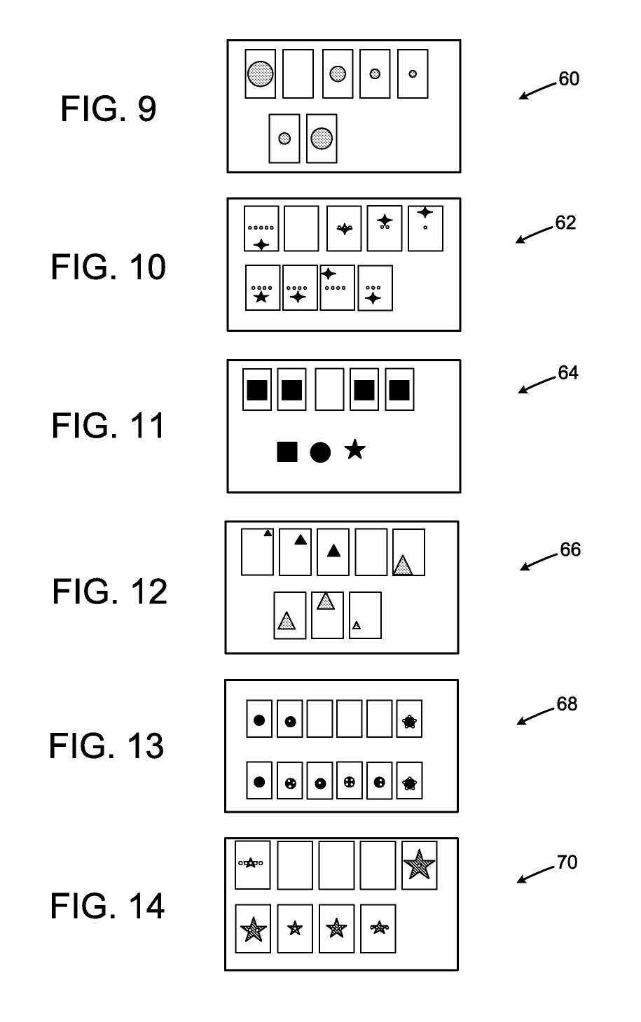

FIGS. 9-14 show exercise examples of problem definition parameters for sequential order exercises. More particularly, FIG. 9 shows an exercise 60 that may be used to illustrate the parameter “number of cards.” The exercise example has five cards and is using size progression as the rule. There is one blank card and the sequence has one distracting card.

FIG. 10 illustrates an exercise example 62 for the parameter “number of distracting cards.” The example shows three distracting cards and the two rules used are position and the number of dots.

FIG. 11 illustrates an exercise 64 to show the parameter “number of rules.” Sequence order exercises may use five different rule dimensions (color, shape, size, number of dots and position) but only four of them are used in progression since shape does not function as progression. The dimension shape is only used in the easiest difficulty levels that do not have progression. Combinations of up to three different rules may be used. The first example shows an easy level without progression where the rule is based on shape. The example has two distracting cards.

FIG. 12 shows an exercise 66 that has three rule dimensions (color, size and position) and has two distracting cards.

FIG. 13 shows an exercise 68 for the parameter “number of blank cards.” The parameter number of blank cards relate to the number of blank cards that are to be filled in with correct cards by the user.

FIG. 14 shows an exercise 70 to illustrate the parameter “position for blank cards.” The position of the blank cards can vary from being in the beginning, in the middle, at the end of the sequence, or randomly. In the example shown, the blank cards are in the middle of the sequence. The parameters are size and the number of dots. There is one distracting card.

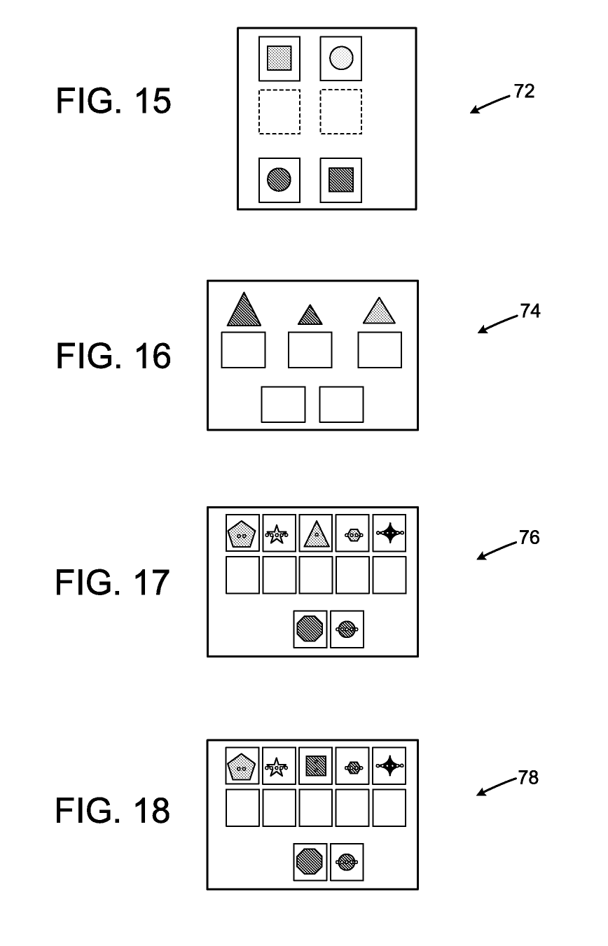

FIGS. 15-18 show examples of problem definition parameters of classification exercises. More particularly, FIG. 15 shows an exercise example 72 for the parameter “number of cards.” The number of cards in the upper row is at least two. Both cards in the lower row are to be matched to each card in the upper row. The rule dimension is shape and the distracting dimension is color.

FIG. 16 shows an exercise example 74 of the parameter “number of distracting cards.” The classification exercises have no distracting cards in the lower row which is different from the other two types of exercises (repeated pattern and sequential order exercises). The distracting cards are instead in the upper row. The example has one distracting card because only two of the cards are to be matched with the upper row. The rule dimension in the example is size and the distracting dimension is color.

FIG. 17 illustrates an exercise 76 for the parameter “number of distracting dimensions.” The number of dimensions may vary, but the parameter that forms the rule cannot be used as a distractor dimension. If the rule is color and the distracting parameter is shape, the user must ignore differences in the shape. In the example the rule dimension is number of spots and the distracting dimensions are shape, size and color.

FIG. 18 illustrates an exercise 78 for the parameter “bi-solubility.” In the classification exercises both response cards must follow the same matching rule. The bi-solubility factor permits one or both of the cards to be matched to other cards than the correct cards on the distracting dimensions. If both cards have bi-soluble answers then they must be in two different distraction dimensions so that there is only one correct answer. In the example both response cards have bi-soluble response alternatives. The rule is the number of dots. The left card is matching one of the distracting cards since the shape is the same. The right card matches another incorrect card by having the same color.

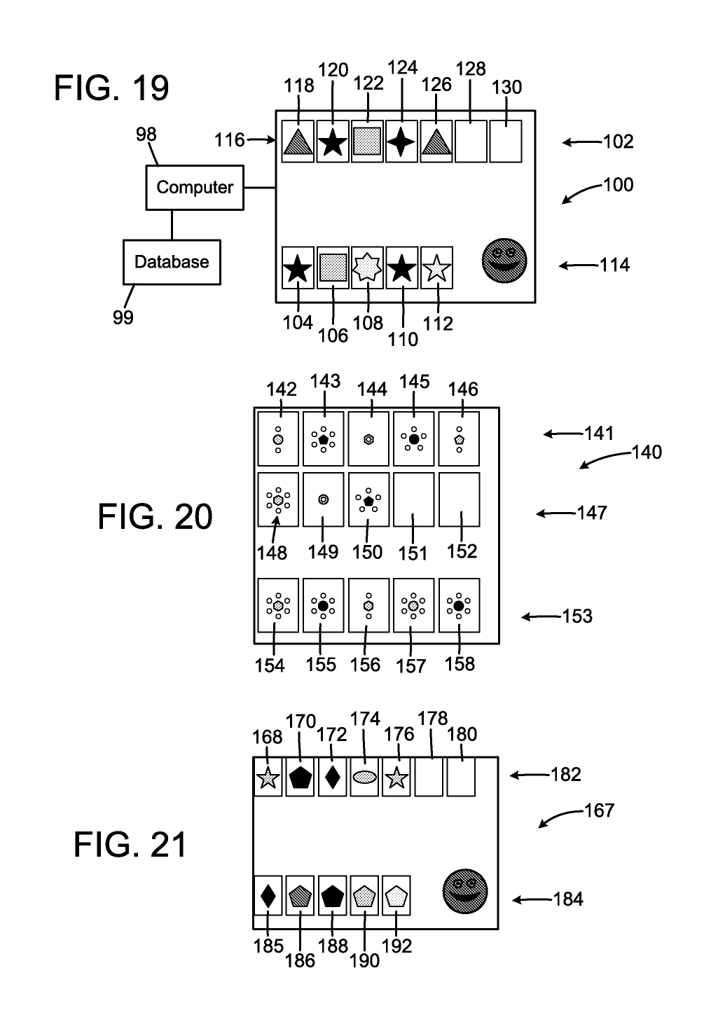

In operation, a computer system 98 has a database 99 to automatically generate a problem task such as a repeated pattern problem 100 as shown in FIG. 19. Preferably, all the underlying definitions for each problem are ranked on a scale from level 1 to N wherein level N is considered the most difficult and level 1 is considered the easiest problem based on empirical tests of previous results of users who have responded to the tasks of the exercises. For example, the number of levels could be 20 or more as required. It should be noted that a problem definition may consist of several parameters and their settings. Additionally, the computer system may decrease or increase the difficulty level of the exercises in decimals e.g. if the level is decreased from level 17.7 to 17.2 then the same problem definition (parameter values) will preferably be used but if the level is reduced from 17.2 to 16.9 a different definition is preferably used when the exercise at level 16.9 is generated. The database 99 may include all the parameters/values as they are ranked. The database may also include the symbols that are used when the exercises are generated. Preferably, the selection of the symbols may be random but the system 98 makes sure that the exercises include or conform to the necessary rules/dimensions of the particular difficulty level of the exercise.

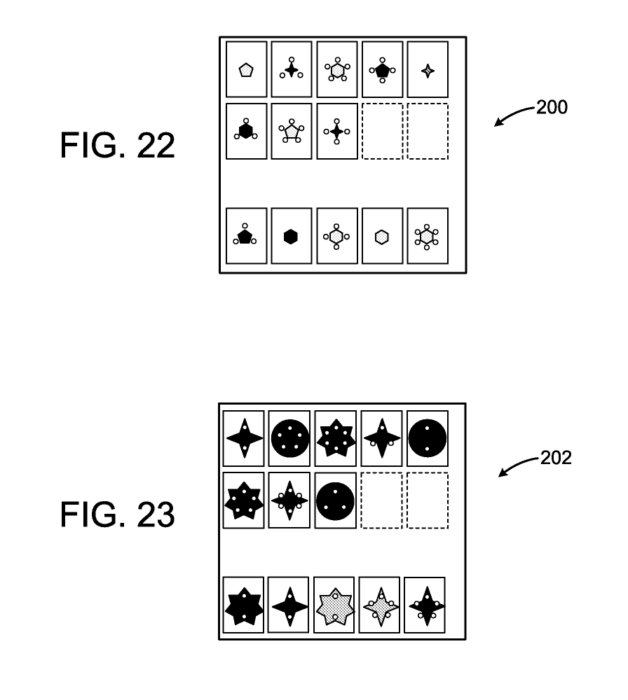

The user may respond to the exercise 102 shown in the upper row 116 by selecting from two cards from the response options in a lower row 114 i.e. a blue star 104 displayed on a card, a yellow square 106 displayed on a card, a yellow seven-pointed shape 108 displayed on a card, a red star 110 displayed on a card and a yellow star 112 displayed on a card in the lower row 114. The upper row 116 may include a pink triangle 118, a red star 120, a yellow square 122, a blue four-pointed shape 124, a pink triangle 126 and two blank cards 128, 130. In an analyzing step, the computer system 98 analyzes whether the response provided is correct or not. If the response is correct then the system generates a new exercise based on the same first set of parameter values or searches the database 99 for a second set of parameter values that match the new higher difficulty level of the next exercises. The first set of parameter values may, for example, be characterized as being at the difficulty level 17.0 while the second set of parameter values may be more difficult and thus characterized as being at difficulty level 18.0. For example, the system 98 may generate a new exercise 140, shown in FIG. 20, based on different parameter values than exercise 102, having been classified as difficulty level 18.0. For example, the new exercise 140 may have a first upper row 141 that includes a gray round shape 142 with a circle disposed below and above, a blue pentagon shape 143 with five circles around it, a gray pentagon shape 144 with a circle disposed inside the shape, a blue round shape 145 with five circles disposed around it, a gray pentagon 146 with a circle disposed one top and below the shape. On a second upper row 147 there is a blue hexagon shape 148 with five circles disposed around it, a gray round shape 149 with a circle disposed inside the shape, a blue pentagon shape 150 with five circles disposed around it, a two blank cards 151, 152. In a lower row 153, there is a yellow hexagon shape 154 with a circle disposed above and below the shape, a blue round shape 155 with five circles disposed around the shape, a gray hexagon shape 156 with a circle disposed above and below the shape, a green round shape 157 with five circles disposed around it, a red round shape 158 with five circled disposed around the shape. If the user later returns to level 17.0, e.g. by answering incorrectly to exercise 140, the system may generate a new exercise that has the same difficulty as exercise 102 such as exercise 167. The difficulty level of exercise 167 may be 17.0 also although it looks different from exercise 102, because it is based on the same parameters, so that the user does not recognize exercise 167 as being identical or at the same difficulty level compared to exercise 102. An important feature of the present invention is that although the difficulty level is the same as exercise 102 the exercise 167 uses different symbols. For example, the exercise 167 may include cards with a light blue star 168, a blue pentagon 170, a red rhomb 172 and green oval 174, another light blue start 576 and two blank cards 178, 180 in the upper row 182. The lower row 184 may include cards that show a red rhomb 185, a pink pentagon 186 and blue pentagon 188, a gray pentagon 190 and a yellow pentagon 192. The system will in this way generate exercises that are either slightly more difficult when the user answers correctly and slightly easier when the user answers incorrectly in order to fine tune the adjustments of the difficulty levels of the exercises at an optimal level. The important feature remains, whether the generated exercises are more difficult or easier, that the cards displayed look different to the user although a new exercise may be at the same difficulty level and train the same rules as a previous exercise. In this way, a certain difficulty level may be mastered by the user although each exercise look differently before the system 98 gradually increases the difficulty level of the exercises. FIGS. 22-23 are examples of additional exercises 200 and 202 that are more difficult than the exercises illustrated in FIGS. 19 and 21 because they, for example, are based on rules/dimensions that are more complicated based on empirical tests and success rates of prior users.

While the present invention has been described in accordance with preferred compositions and embodiments, it is to be understood that certain substitutions and alterations may be made thereto without departing from the spirit and scope of the following claims.

1. A method for computerized training and improving fluid intelligence of a user, comprising:
providing a first pattern of symbols that follows a first set of parameter values;
the user responding in a first response to the first pattern of symbols by selecting response options;
a computer determining whether the first response is correct;
when the first response is correct, the computer generating a second pattern that is different than the first pattern, the second pattern being more difficult than the first pattern;
the user responding in a second response to the second pattern;
the computer determining whether the second response is correct;
when the second response is incorrect, the computer generating a third pattern that is different from the first pattern, the third pattern being based on the first set of parameter values;
when the first response is incorrect, the computer generating a fourth pattern that is less difficult than the first pattern; and
when the second response is correct, the computer generating a fifth pattern that is more difficult than the second pattern.

2. The method according to claim 1 wherein the method further comprises the computer searches in a database for parameter values that matches a difficulty level prior to generating symbols that display the first pattern.

3. The method according to claim 1 wherein the method further comprises the computer automatically generating symbols to be displayed to the user.

4. The method according to claim 1 wherein the method further comprises the computer searches for a second set of parameter values prior to generating the second pattern, the second set of parameter values being more difficult compared to the first set of parameter values.

5. The method according to claim 1 wherein the method further comprises the user responding to non-verbal reasoning tasks.

6. The method according to claim 1 wherein the method further comprises providing the first pattern only with geometrical figures.
